(19) United States
(12) Patent Application Publication
(10) Pub. No.: US 2026/0087551 A1
(43) Pub. Date: Mar. 26, 2026

(54) SYSTEMS AND METHODS FOR INTEGRATING FINANCIAL DUE DILIGENCE AND PROPERTY ACQUISITION TO A PROPERTY MANAGEMENT SOFTWARE FOR A RESIDENTIAL REAL ESTATE LISTING SITE

(71) Applicant: Thomas Aloysius Lynam, IV, Chadds Ford, PA (US)

(72) Inventor: Thomas Aloysius Lynam, IV, Chadds Ford, PA (US)

(21) Appl. No.: 18/891,724

(22) Filed: Sep. 20, 2024

(51) Int. Cl. G06Q 40/06; G06Q 50/16

(52) U.S. Cl. CPC G06Q 40/06; G06Q 50/16

(57) ABSTRACT

A system for automating financial due diligence processes for a real estate property is disclosed, including at least one user computing device in operable connection with a user network. An application server is in operable communication with the user network to host an application program for enabling the automation of financial due diligence for a real estate property. An advanced search engine searches a property listing database and displays a plurality of properties meeting at least one input related to a financial data metric. An assumption module receives a plurality of assumptions from a real estate property listing and a plurality of real estate data. A financial modelling module generates a plurality of models using the plurality of assumptions. A scoring and analysis module calculates a score associated with the real estate property which is displayed on a property listing interface to indicate a potential value of the real estate property.

### TECHNICAL FIELD

The embodiments disclosed herein generally relate to computer-implemented systems and methods for automating financial due diligence processes for residential real estate properties.

### BACKGROUND

Throughout the process of a real estate transaction, financial analysis of various aspects of the transaction including the real estate asset and involved parties is performed. Commonly, data input and spreadsheet software (e.g., Excel) is used to perform the analysis. While effective, these platforms have limitations including the inability to automate various functions to generate assumptions at scale, then code a Visual Basic for Applications (VBA) to limit the manual steps. In theory, some may create a database of historic data and set up a statistical analysis function. However, when spreadsheet software is used at this scope it has a propensity to crash while running the VBA, or at minimum, operate slowly. The more complex the spreadsheet becomes, the likelihood of it not operating properly increases. Further, in this example data is still manually uploaded and is limited to an individual computer or closed network.

Currently available spreadsheet software offer a rigid structure. When building a model, the first step is to build a structure which includes the length of the hold period and whether it will be a monthly or annualized model. Although most assumptions can be easily changed, executing a change requires the user to rebuild the model or make significant changes to the structure. This requires significant time and increases the likelihood for errors. In summary, while current spreadsheet software is useful, their rigidity results in a lack of flexibility needed to seamlessly automate financial due diligence tasks. These software programs are known to be complex, often taking users years to master in order to utilize their full potential. This results in many real estate investors to be limited to their own knowledge of how to properly and effectively use the software.

Numerous property management and analysis software systems are currently available, each having their own key features. Most often, these systems are intended for managing properties which have already been purchased. Some platforms exist which are able to conduct Internal Rate of Return (IRR) and Net Present Value (NPV) calculations using a Discounted Cashflow (DCF). However, these systems require property data and assumptions to be uploaded and/or entered manually. Further, current systems are tailored to commercial real estate properties, rather than residential real estate properties.

Websites exist which link to a multiple listing service (MLS) to provide property information and estimates. However, these systems are mainly used as advertisement platforms and do not perform financial analysis other than providing simple estimates of some financial information such as mortgage estimates.

In summary, platforms and software exist which specialize in particular functionalities pertaining to real estate property searches, investment, management, and financial due diligence. However, investors must use multiple non-integrated systems to manage and develop their real estate portfolio.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system for automating financial due diligence processes for a real estate property, including at least one user computing device in operable connection with a user network. An application server is in operable communication with the user network to host an application program for enabling the automation of financial due diligence for a real estate property. An advanced search engine searches a property listing database and displays a plurality of properties meeting at least one input related to a financial data metric. An assumption module receives a plurality of assumptions from a real estate property listing and a plurality of real estate data. A financial modelling module generates a plurality of models using the plurality of assumptions. A scoring and analysis module calculates a score associated with the real estate property which is displayed on a property listing interface to indicate a potential value of the real estate property.

The system provides an automated means of analyzing financial due diligence information which is automatically generated and displayed for each property. This reduces errors and time needed to analyze the property's financial information and investment potential, which has historically been performed manually using spreadsheet software.

The system may be integrated with a property management platform to provide a comprehensive view of property information related to investment opportunities as well as a tool for managing the user's pre-existing investments.

In some aspects, the financial data metric comprises at least one of the following: an ROI, a cashflow amount, an IRR, an NPV, and a Cap Rate.

In some aspects, the advanced search engine provides the ability for users to set assumptions that are within their control, such as a hold period, renovation budget, down payment percentage, and the like to look for returns that best suit their investment strategy.

In some aspects, the assumption module autonomously generates property-specific financial assumptions by leveraging historical data and statistical analysis. This includes financial metrics such as appreciation rates, rent estimates, vacancy rate, maintenance costs, etc.

In some aspects, the system includes a property management module in operable communication with a property management platform to enable to management of a purchased property. The property management module includes user portals for both the tenant and landlord.

In some aspects, the property management module enables the transmission of actual property financial information to the property management database to monitor and audit a plurality of investment metrics.

In some aspects, the system includes an assumptions interface to enable the input, display and user interaction with the plurality of assumptions.

In some aspects, the system includes a model interface to enable the input, display, and user interaction with the plurality of models. The integrated financial models may include Pro forma income statements, amortization schedules, resale projections, unleveraged cashflow analysis, and leveraged cashflow analysis. These models provide a detailed financial analysis for each property, allowing for in-depth analysis without the user navigating away from the listing platform.

In some aspects, the system includes a calculation interface to enable the input, display, and user interaction with a plurality of calculations associated with the plurality of assumptions and the plurality of models.

In some aspects, the system includes a sensitivity analysis interface to enable the input, display, and user interaction with a plurality of sensitivity data associated with the real estate property. The sensitivity analysis information may be used to aid the user in visualizing the impact of changing various assumptions on key financial metrics to provide a robust understanding of potential risks and opportunities.

In some aspects, the models may provide a score which is generated using the scoring module which evaluates a property's unleveraged IRR relate to market averages, allowing the user to quickly assess the property's potential value.

A method for automating financial due diligence processes for a real estate property is disclosed. The method includes an automatically generated assumption module establishing and associating a plurality of assumptions with a real estate property. The plurality of assumptions are input into a financial analysis model operated by a financial model module. The financial model module is then utilized to generate a plurality of financial analysis information including a score which is calculated by a scoring module. The score may then be associated with the real estate property and displayed on the property listing interface to provide users with a convenient and efficient means of assessing the properties investment potential.

Prior to purchasing a property, the user may utilize the systems and methods to run various scenarios for the property each using various assumptions. In such, the user can analyze the properties potential value using various assumptions each corresponding to a unique scenario. The scenarios may then be saved. The execution of various scenarios allows the user to account for uncertainty in the market, thus providing a means of assessing the properties financial returns considering various factors which may change in the particular market.

Once a property has been purchased, the saved scenario can be pulled into the property management portal. This will be used as the initial forecast for the property. With the scenario being tied to the listing, the other attributes of the property (square footage, bedroom count, bathroom count, etc.) will also be saved to the property management site. This can be used to build a property profile within the landlord's portal automatically. This will increase organization and reduce the need to manually enter these details for record keeping purposes.

In some aspects, the method may also include the steps of a purchasing, via a user, the real estate property. Once purchased, financial analysis information is then transmitted to a property management platform operating a property management module. The property management platform and module enable the continuous updating of financial information associated with the purchased property. This may be done in real-time to enable the user (i.e., the investor) to monitor and manage the performance of their investment property. This is accomplished by transmitting the real-time data to the assumption module and financial modelling module for reprocessing of the data.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the computer system and application program, according to some embodiments;

FIG. 3 illustrates a block diagram do the application program and database infrastructure, according to some embodiments;

FIG. 4 illustrates a method for using the system to manage financial due diligence processes for a real estate property, according to some embodiments;

FIG. 5 illustrates a flowchart of a process for automating financial due diligence for a real estate property, according to some embodiments;

FIG. 6 illustrates a screenshot of a real estate listing interface including the real estate property information, according to some embodiments;

FIG. 7 illustrates a screenshot of the assumptions interface which displays assumptions based on the real estate property information, according to some embodiments;

FIG. 8 illustrates a screenshot of the model interface which displays financial information based on financial data input into the system, according to some embodiments;

FIG. 9 illustrates a screenshot of the model interface which displays financial information based on financial data input into the system, according to some embodiments;

FIG. 10 illustrates a screenshot of the calculation interface which displays financial due diligence metrics, according to some embodiments; and

FIG. 11 illustrates a screenshot of the sensitivity analysis interface which displays risk analysis information based on various assumptions input into the system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems and methods for automating financial due diligence processes for residential real estate properties. It is common for real estate investors to perform various financial analytics and due diligence when analyzing a real estate property that is for sale. Historically, these processes have been done manually through the implementation of spreadsheet software which requires significant experience and technical ability. The embodiments provided herein provide a platform which streamlines the process of performing financial due diligence in an efficient an automated program which reduces the time and technical ability needed to procure financial due diligence data.

In some embodiments, the system includes an advanced search features which will provide the ability for users to search real estate properties that have specific cashflow, IRR, NPV, ROI, Cap Rate, etc. The user will be able to set assumptions that are within their control, such as a hold period, renovation budget, down payment percentage, and the like to look for returns that best suit their investment strategy.

In some embodiments, the system includes a property detail interface similar to existing listing websites. However, the system includes a score or rating for each property which is calculated using the financial models used by the system. This allows the user to efficiently evaluate the property using the displayed score and view financial information, assumptions, models, and sensitivity analysis data related to and associated with the specific property represented by the real estate property listing.

The system utilizes an assumptions module to autonomously generate property-specific financial assumptions by leveraging historical data and statistical analysis. This includes financial metrics such as appreciation rates, rent estimates, vacancy rate, and maintenance costs.

The system utilizes integrated financial models which are incorporated into the property listing platform. This may include Pro forma income statements, amortization schedules, resale projections, unleveraged cashflow analysis, and leveraged cashflow analysis. These models provide a detailed financial analysis for each property, allowing for in-depth analysis without the user navigating away from the listing platform.

In some embodiments, the models may provide a score which is generated using a scoring module which evaluates a property's unleveraged IRR relate to market averages, allowing the user to quickly assess the property's potential value.

In some embodiments, the system may include an adjustable assumption for “personal use”. This can either consist of an apartment in a multifamily property that the landlord is living in or the portion of the year the investor is staying at their short-term rental (Airbnb, beach house, etc.). This feature adjusts deprecation for tax purposes; however, it can also be used to calculate the opportunity cost of using the investment property for personal use.

In some embodiments, the models may provide sensitivity analysis to aid the user in visualizing the impact of changing various assumptions on key financial metrics to provide a robust understanding of potential risks and opportunities.

In some embodiments, the system allows the user to save and compare multiple financial scenarios for each property to facilitate thorough analysis and decision-making. Prior to purchasing a property, the user may utilize the systems and methods to run various scenarios for the property each using various assumptions. In such, the user can analyze the properties potential value using various assumptions each corresponding to a unique scenario. The scenarios may then be saved. The execution of various scenarios allows the user to account for uncertainty in the market, thus providing a means of assessing the properties financial returns considering various factors which may change in the particular market.

In some embodiments, the system provides property management integration functions to enable a seamless transition from analysis of the property to management of the property following its purchase. This allows users to manage and monitor performance against the projects. This data along with the updated metrics may then be fed back into the system to improve future analysis.

In some embodiments, the system incorporates an artificial intelligence (AI) engine which enables a summary analysis to be written for the financial models associated with a particular scenario. This improves the useability by mitigating the need for previous financial knowledge to not only build the model and also aids the user in the interpretation of the models and calculations.

In some embodiments, the system includes an accounting and bookkeeping feature that may be incorporated to other portions of the management software. As rent is collected and select expense are paid for through the software, these transactions will automatically be fed into the accounting software. This drastically reduces the need for manually entry and bookkeeping, reducing errors and time. After the property financials are put together, the new actuals (i.e., realized financial metrics) will then feed into the financial forecast. This will automatically update the original financial budget on a monthly basis. The main benefit to this, however, will be that as the actuals are being fed back into the system and used to improve the assumptions.

In some embodiments, properties in the property management platform will be able to be seamlessly posted to the listing sight when they are ready to be rented.

In some embodiments, the property management platform will have an integrated tenant screening feature. This will conduct background checks, employment and income verification and credit reports.

In some embodiments, the property management platform may include a tenant portal will allow tenants to pay online by card or ACH. This feature will allow the rental income of the landlords financial to become automated and eliminate the need for manual input.

In some embodiments, the tenant portal may provide the ability to put in a maintenance request through their portal. The request will then be sent to the landlord for approval. The landlord will then have the ability to approve the request. After the request is approved, the request will then be sent to an electrician, plumber, etc. that is partnered with the management system. The landlord will then be invoiced and have the ability to pay through the portal. This transaction will then automatically be uploaded into the financials mitigating all manual inputs.

In some embodiments, the system includes document management functionalities which allow both the landlord and tenant to store their related documents in an organized manor.

In some embodiments, the landlord will have an interactive dashboard that measures key metrics of their properties. In such, the system provides a comprehensive means of improving analysis of real estate property performance by automating assumptions, analysis, and modeling for each property in a portfolio.

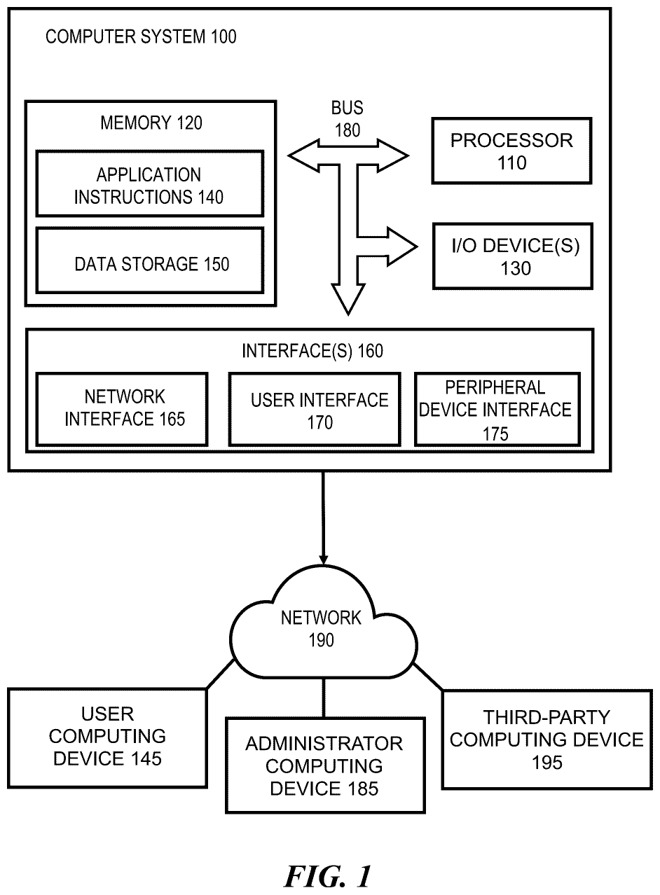

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

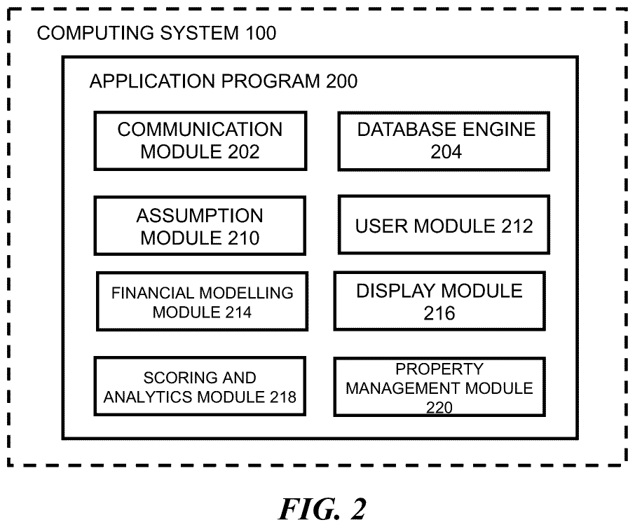

FIG. 2 illustrates an example computer architecture for the application program 200 operated via the computing system 100. The computing system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an assumption module 210, a user module 212, a financial modelling module 214, a display module 216, a scoring and analytics module 218, and a property management module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

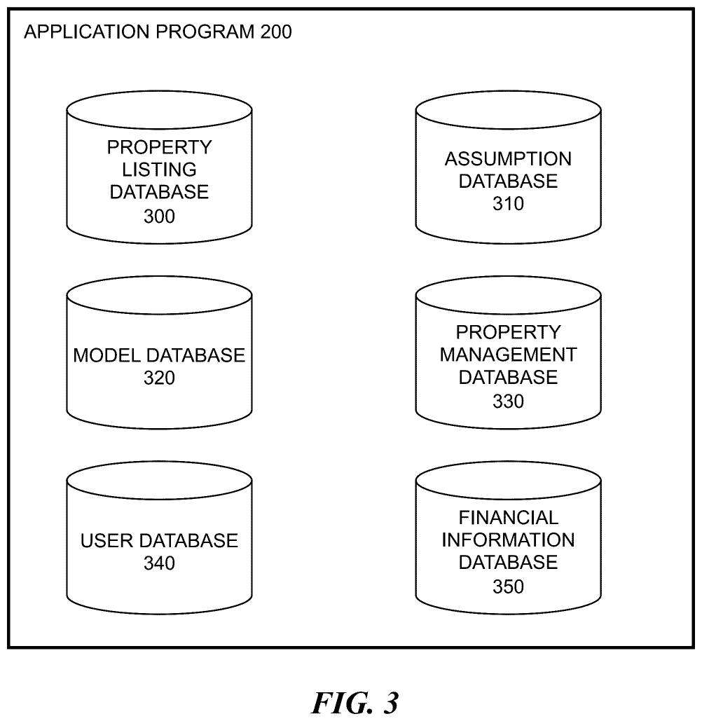

In some embodiments, the database engine 204 is in communication with each database described in FIG. 3 as well as the property management platform to enable data to be transferred throughout the system.

In some embodiments, the assumption module 210 receives and analyzes information from the property listing and utilizes this information to form assumptions. The assumptions are used by the financial modelling module 214 to automatically generate models. Some assumptions can be found directly on the listing site: Home Price, Square Footage, HOA fee, etc. Others can be calculated as a standard percentage or amount: Closing Cost, Down Payment, Building Life (for depreciation), 30 year Loan APR. The remaining assumptions may be calculated by using localized historic data to find trends. These trends will most likely be calculated by using R or Python Pandas (both have the same functionality, but one may be favorable for integration purposes) to run statistical regressions. Data may include: Appreciation Rate, Utilities and Insurance, Tax, Rent, Vacancy, Maintenance Cost, Working Capital, and Discount Rate. The calculations for the assumptions will also tie into the property management software so that as users plug in their actual metrics, the assumptions can become more accurate. Users will have the option to enter renovation amount for an individual property or set a personal budgeted renovation amount that can be accounted for in the advance search.

In some embodiments, the user module 212 facilitates the creation of a user account for the application system. The user module 212 may allow the user to create a user profile which includes user information, user preferences, and user-associated information. The user module may also be used to assign a user type to each user. The user module may enable the user to establish preferences which may include inputs for financial metrics, investment goals, risk tolerance, etc.

In some embodiments, the financial modelling module 214 is in operable communication with the application program 200 to enable the automated generation of financial models using various financial information data and assumptions received from the assumption module 210. Individual line items can be expanded or reduced to show the breakdown of what goes into the line item. (e.g., Operating Expenses can either be seen as Operating Expense or can be expanded into HOA, Insurance, Utilities, Maintenance and Repairs.) The models can also be displayed for a set period of time that is set as an assumption and can be viewed either monthly or annualized.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the scoring and analytics module 218 may utilize various financial information data which is sued to generate a score associated with the real estate property.

### Pro Forma Income Statement

The Pro Forma Income Statement starts with the Gross Revenue that is brought in from rent. Expenses and depreciation are then reduced from Gross Revenue in order to get Earnings Before Interest and Tax (EBIT). Interests is then reduced from EBIT to get EBT. Tax is then reduced from EBT to get Net Income.

### Amortization Schedule (Loan Balance and Payments)

The Amortization Schedule breaks down the loan payment. It starts with the Beginning Balance. The Beginning Balance is then multiplied by the APR to get the Interest Expense. The Interest Expense is then subtracted from the PMT or monthly payment to get the Principal Payment. The Principle Payment is then subtracted from the Beginning Balance to get the Ending Balance. The Ending Balance, then becomes the next Beginning Balance.

$$PMT = [ PV * ( APR / 12 ) ] / [ 1 - {( 1 + ( APR / 12 ) )}^{⋀} ( - n ) ]$$

### Resale Schedule

The Resale Schedule shows Working Capital needed. It then has the Book Value, which is the Purchase Price plus Closing Cost less depreciation. It then has the Market Value which is the Purchase Price plus appreciation. At the end of the holding period, commission is reduced from the final Market Value to get the Net Final Market Value.

### Unlevered Free Cashflow

The Unlevered Free Cashflow starts with EBIT from the Pro Forma Income Statement and is then reduced by the tax amount (tax does not include the interest expense that is deducted in the Income Statement). It then accounts for the Purchase Price and Closing Cost at the time of purchase and the Net Resale when the property is sold. Depreciation is then added back in. The Change in Net Working Capital is then accounted for. All pervious lines are then either subtracted or added depending on if the money was going out or coming in and then the sum is the Unlevered Cashflow.

Net Resale=Net Final Market Value−(Capital Gains Tax*(Net Final Market Value−Book Value))

### Leveraged Cashflow

The Leveraged Cashflow starts with the Net Income from the Pro Forma Income Statement. It then accounts for the Purchase Price and Closing Cost at the time of purchase and the Net Resale when the property is sold. Depreciation is then added back in. The Change in Net Working Capital is then accounted for. The Loan Balance line from the Amortization Schedule is then added, while starting with the Initial Loan amount at the time of purchase. All pervious lines are then either subtracted or added depending on if the money was going out or coming in and then the sum is the Levered Cashflow.

### Calculation:

### Internal Rate of Return (IRR):

$$I R R - {[ ( FV ) / ( PV ) ]}^{⋀} ( 1 / Periods ) - 1$$

### Net Present Value (NPV):

$$N P V = \sum n [ cash flow / {( 1 + r )}^{⋀} n ] - initial investment$$

Payback Period: (i.e., the time it takes for the initial investment to be recouped)

### ROI:

$$R O I = Net Profit / Cost of investment$$

### Cap Rate:

$$Cap Rate = Net Operating Income / Current Market Value of Asset I R R , N P V , and Payback Period needed for the Cashflow model to properly calculate .$$

In some embodiments, the property management module 220 facilitates the integration of the automated system with a property management platform. This enables the user to monitor the investment performance of properties they have purchased. Data gathered by the property management module may be used to make improvements to the system's future models and scores.

In some embodiments, once financial due diligence is complete and the user goes through and buys the property, the user can then pull the scenario that they like the most into the property management. This model will then become the properties forecast. The property management website will be able to perform all necessary bookkeeping tasks and allow users to update their forecast with actuals. These actuals will then be fed back into the calculation to develop more acuate assumptions. This will be done by not only gaining access to more reliable data, but also check to insure that the assumptions being made are close to the actual cost being entered.

In some embodiments, when performing a financial analysis using financial models, scenarios may be saved within the application program databases to allow the user to attempt to predict the future to understand what their future returns are going to be (as is related to each individual scenario). As a result, it is important to run through various scenarios on how things could end up playing out. The saved scenarios will give the users not only the ability to save the property but also all their scenarios.

FIG. 3 illustrates a block diagram do the application program and database infrastructure which includes a property listing database 300, an assumption database 310, a model database 320, a property management database 330, a user database 340, and a financial information database 350. The property listing database 300 is configured to store a plurality of property listings received from a property listing site, MLS, advanced search engine, etc. The property listing database enables the user to store properties for future analysis. An assumption database 310 stores assumption-related information which is input by the user and/or generated automatically by the system using the property listing information, user preferences, financial information, and the like. The model database 320 stores models which are input by the user and/or automatically generated by the system. The property management database 330 stores information associated with purchased properties which are used by the property management platform. The user database 340 stores user information including user credentials, personal information, user financial information, and other information associated with the user. The financial information database 350 may store various financial information associated with the user which can be used by the system to automatically generate assumptions, models, and suggestions related to properties and opportunities.

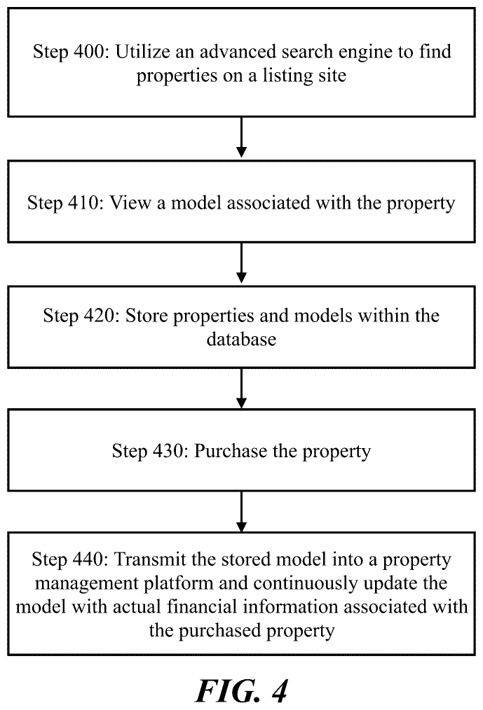

FIG. 4 illustrates a method for using the system to manage financial due diligence processes for a real estate property. In step 400, an advanced search engine is utilized to find properties on a listing site. In step 410, a model is viewed which is associated with the property selected from the property listing interface. In step 420, properties and models are stored within the database. In step 430, the property is purchased by the user if the property meets the users' preferences. In step 440, the stored model is transmitted to a property management platform and is continuously updated with real-world financial information associated with the purchased property.

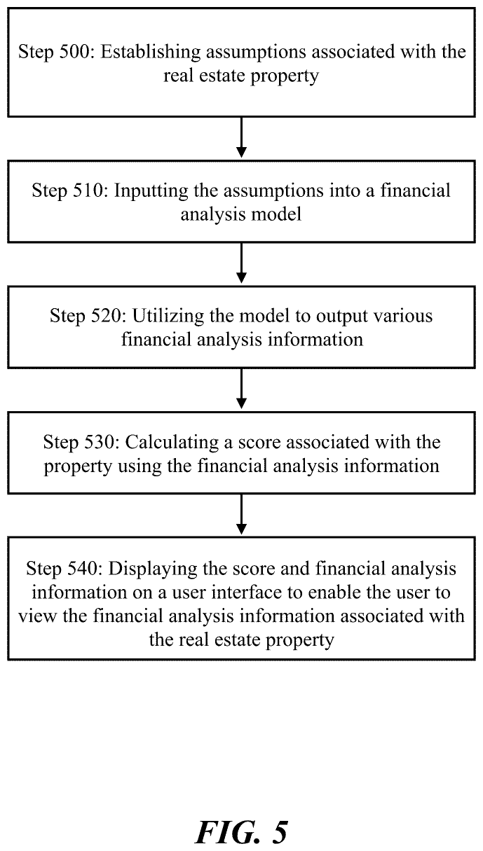

FIG. 5 illustrates a flowchart of a process for automating financial due diligence for a real estate property. In step 500, assumptions are established and associated with the real estate property. In step 510, the assumptions are input into a financial analysis model. In step 520, the model is utilized to output various financial analysis information. In step 530, a score is calculated and associated with the property using the financial analysis information. In step 540, the score and financial analysis information is displayed on the user interface to enable the user to view the financial analysis information associated with the real estate property.

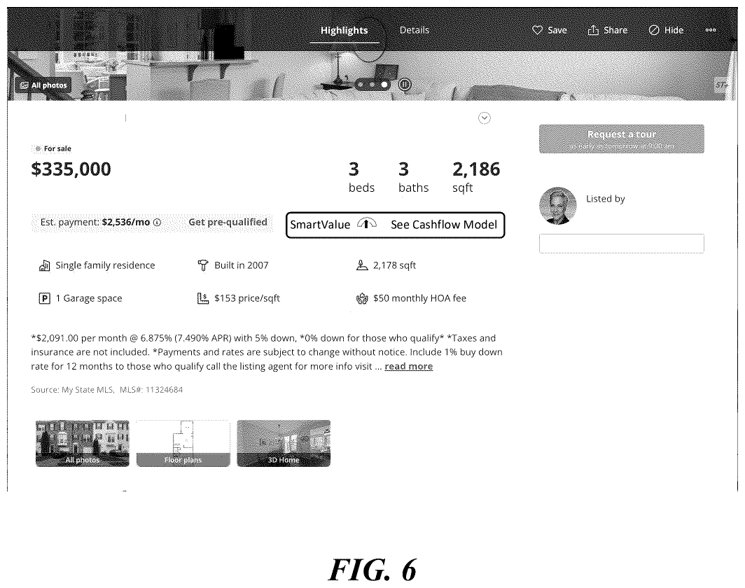

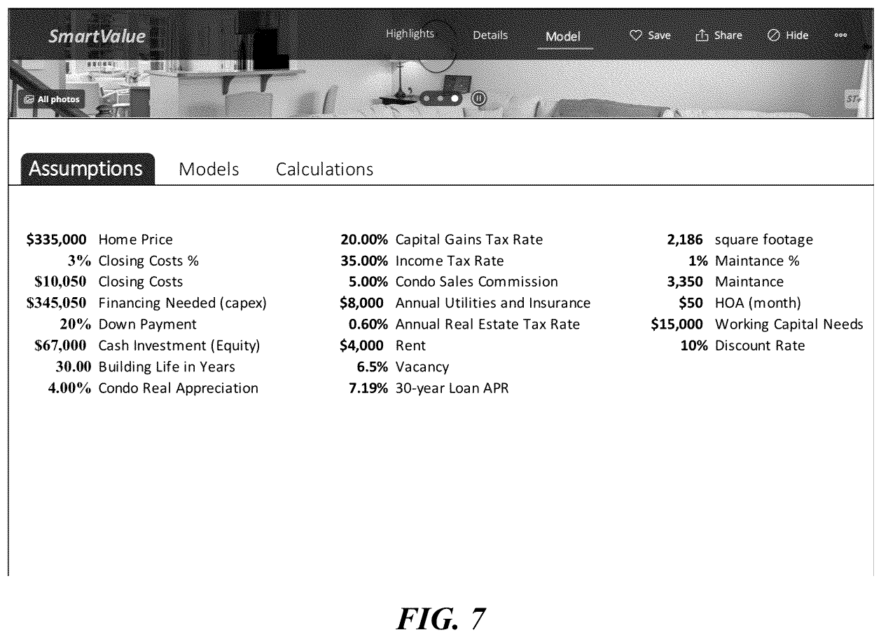

FIGS. 6-11 illustrates various exemplary user interfaces displayed, via the display module, on the display of a computing device operating the application program. FIG. 6 illustrates a property listing interface including the real estate property information, financial information data associated with the real estate property, and other metrics. FIG. 7 illustrates the assumptions interface which displays assumptions based on the real estate property information. Assumptions may include, for example, home price, closing cost %, closing costs, financing, down payment %, cash investment, building life (in years), condo real appreciation, capital gains tax rate, income tax rate, condo sales commission, annual utilities and insurance, annual real estate tax rate, rent, vacancy rate, loan details, square footage, maintenance, HOA, working capital needs, and discount rate.

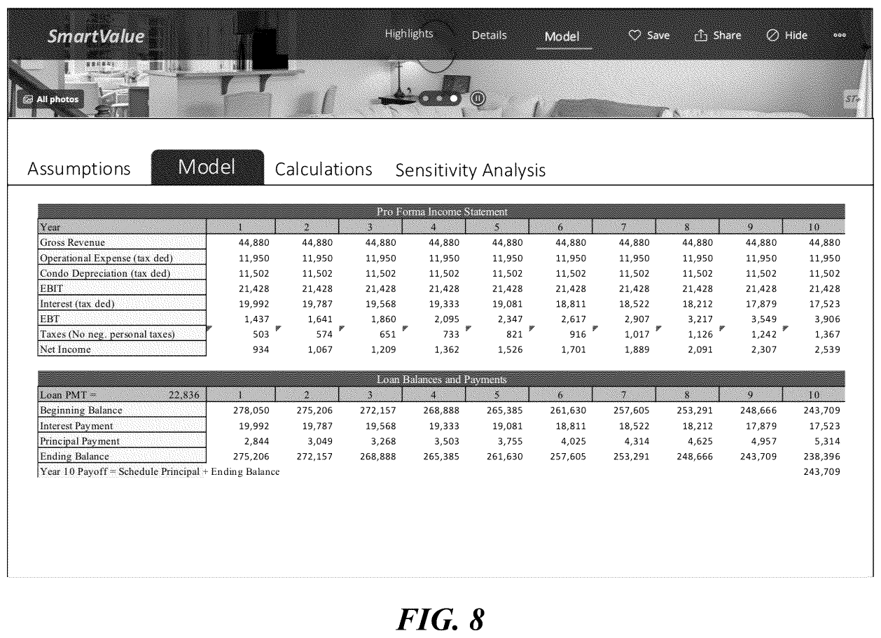

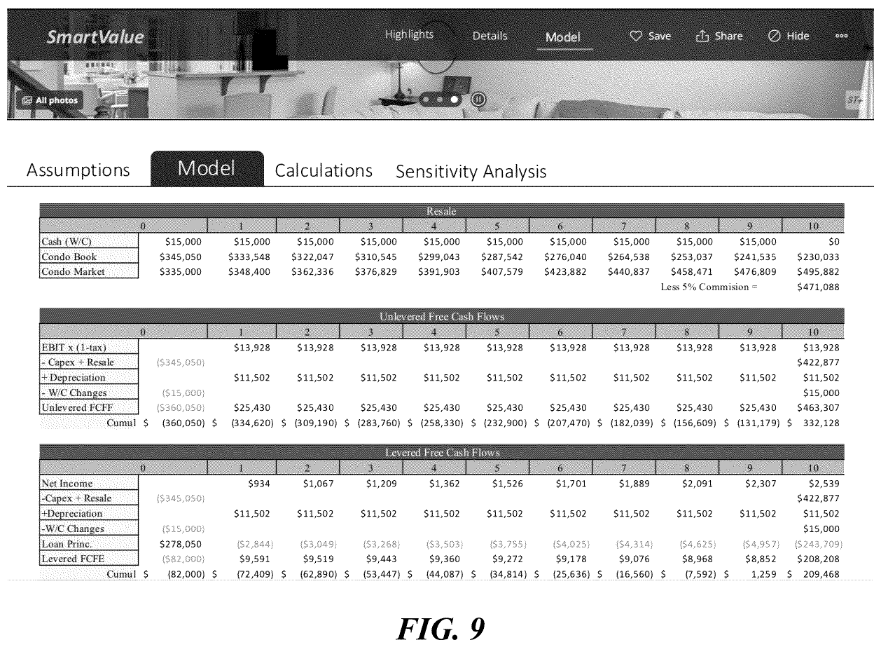

FIG. 8 and FIG. 9 illustrate screenshots of the model interface which displays financial information based on financial data input into the system. The financial information data may include gross revenue, operation expenses, condo depreciation, EBIT, interest, EBT, taxes, net income, loan PMT, balances, interest payment, principal payment, ending balance, year 10 payoff, cash, condo book, condo market, capex, depreciation, W/C chargers, unleveraged FCFF, etc.

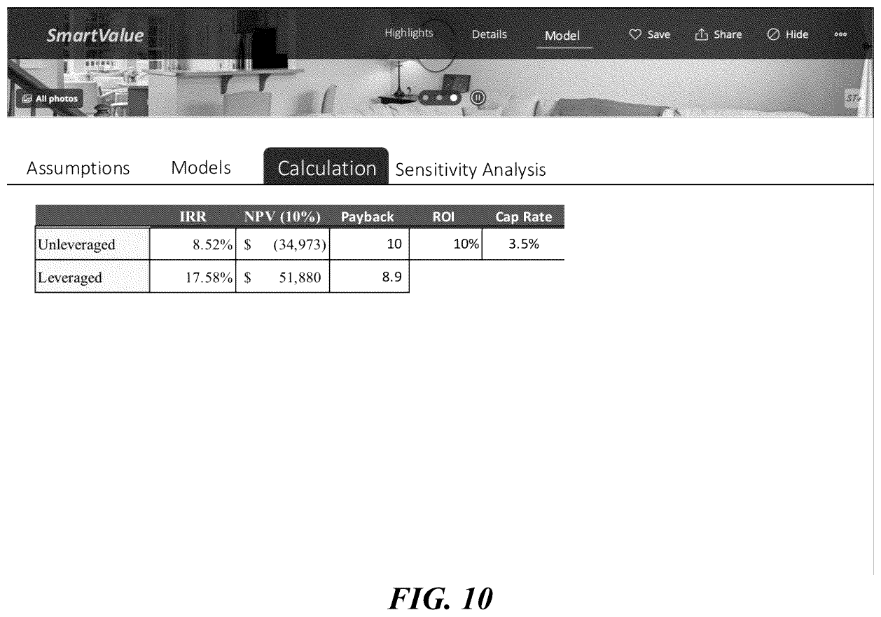

FIG. 10 illustrates a screenshot of the calculation interface which displays financial due diligence metrics which provides both unleveraged and leveraged values related to the IRR, NPV, payback, ROI and Cap Rate.

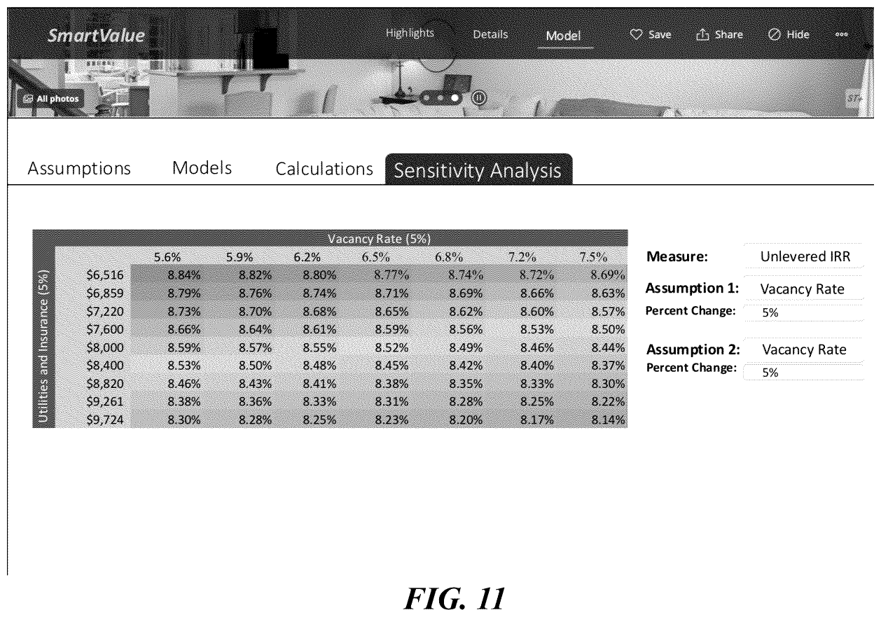

FIG. 11 illustrates a screenshot of the sensitivity analysis interface which displays risk analysis information based on various assumptions input into the system. They may include various factors which affect the profitability of the investment property such as utilities and insurances costs, vacancy rates, etc.

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for automating financial due diligence processes for a real estate property, the system comprising:
at least one user computing device in operable connection with a user network;
an application server in operable communication with the user network, the application server configured to host an application program for enabling the automation of financial due diligence for a real estate property;
an advanced search engine to search and display a plurality of properties meeting at least one input, the at least one input related to a financial data metric;
an assumption module to receive a plurality of assumptions from a real estate property listing and a plurality of real estate data;
a financial modelling module to generate a plurality of models using the plurality of assumptions;
a scoring and analysis module to calculate a score associated with the real estate property, the score being displayed on a property listing interface to indicate a potential value of the real estate property.

2. The system of claim 1, wherein the financial data metric comprises at least one of the following: a Return on Investment (ROI), a cashflow amount, an Internal Rate of Return (IRR), a Net Present Value (NPV), and a Cap Rate.

3. The system of claim 2, wherein the score is correlated to the Internal Rate of Return (IRR).

4. The system of claim 1, further comprising a property management module in operable communication with a property management platform to enable to management of a purchased property.

5. The system of claim 4, wherein the property management module enables the transmission of actual property financial information to the property management database to monitor a plurality of investment metrics.

6. The system of claim 1, further comprising an assumptions interface to enable the input, display and user interaction with the plurality of assumptions.

7. The system of claim 1, further comprising a model interface to enable the input, display, and user interaction with the plurality of models.

8. The system of claim 1, further comprising a calculation interface to enable the input, display, and user interaction with a plurality of calculations associated with the plurality of assumptions and the plurality of models.

9. The system of claim 1, further comprising a sensitivity analysis interface to enable the input, display, and user interaction with a plurality of sensitivity data associated with the real estate property.

10. A system for automating financial due diligence processes for a real estate property, the system comprising:
at least one user computing device in operable connection with a user network;
an application server in operable communication with the user network, the application server configured to host an application program for enabling the automation of financial due diligence for a real estate property, the application program in operable communication with a processor to perform the following:
search a property listing database, using an advanced search engine, a plurality of properties meeting at least one input related to a financial data metric;
receive, via an assumption module, a plurality of assumptions from a real estate property listing and a plurality of real estate data;
generate, via a financial modelling module, a plurality of models using the plurality of assumptions;
calculate, via a scoring and analysis module, a score associated with the real estate property, the score being displayed on a property listing interface to indicate a potential value of the real estate property.

11. The system of claim 10, wherein the financial data metric comprises at least one of the following: a Return on Investment (ROI), a cashflow amount, an Internal Rate of Return (IRR), a Net Present Value (NPV), and a Cap Rate.

12. The system of claim 10, wherein the score is correlated to the Internal Rate of Return (IRR).

13. The system of claim 12, further comprising a property management module in operable communication with a property management platform to enable to management of a purchased property.

14. The system of claim 13, wherein the property management module enables the transmission of actual property financial information to the property management database to monitor a plurality of investment metrics.

15. The system of claim 10, further comprising an assumptions interface to enable the input, display and user interaction with the plurality of assumptions.

16. The system of claim 10, further comprising a model interface to enable the input, display, and user interaction with the plurality of models.

17. The system of claim 10, further comprising a calculation interface to enable the input, display, and user interaction with a plurality of calculations associated with the plurality of assumptions and the plurality of models.

18. The system of claim 10, further comprising a sensitivity analysis interface to enable the input, display, and user interaction with a plurality of sensitivity data associated with the real estate property.

19. A method for automating financial due diligence processes for a real estate property, the method comprising the steps of:
establishing and associating, via an assumption module, a plurality of assumptions with a real estate property;
inputting the plurality of assumptions into a financial analysis model operated via a financial model module;
utilizing the financial analysis model to generate a plurality of financial analysis information;
calculating, via a scoring module, a score;
associating the score with the real estate property; and
displaying the score on a property listing interface.

20. The method of claim 19, further comprising the steps of:
purchasing, via a user, the real estate property;
transmitting, via an application server, the plurality of financial analysis information to a property management platform;
updating, the financial information associated with the purchased property in real-time to enable the monitoring and management of the real estate property performance.
